(19) United States
(12) Patent Application Publication
(10) Pub. No.: US 2022/0347036 A1
(43) Pub. Date: Nov. 3, 2022

(54) Rehabilitation Apparatus for Deep Myofascial Release and Stretching

(71) Applicant: Craig Arthur Dossman, Long Beach, CA (US)

(72) Inventor: Craig Arthur Dossman, Long Beach, CA (US)

(21) Appl. No.: 17/733,925

(22) Filed: Apr. 29, 2022

Related U.S. Application Data
(60) Provisional application No. 63/181,905, filed on Apr. 29, 2021.

(51) Int. Cl. A61H 1/02; A63B 23/035

(52) U.S. Cl. CPC A61H 1/02; A63B 23/035; A61H 2201/1638; A61H 2203/0406

(57) ABSTRACT

A rehabilitation apparatus for deep myofascial release and stretching includes an elevated frame, at least one support arm, a height adjustable mechanism, at least one pressure releasing attachment, a first handle, and a second handle. The pressure releasing attachment is rotatably attached to the support arm. The support arm is operatively coupled to the elevated frame, wherein the support arm enables the pressure releasing attachment to rotate above the ground surface. The height adjustable mechanism is operatively coupled to the elevated frame, wherein the height adjustable mechanism changes the operational height of the pressure releasing attachment. The first handle and the second handle are oppositely positioned of each other about the pressure releasing attachment as the first handle is mounted to the elevated frame, and the second handle is mounted to the elevated frame.

The current application claims a priority to the U.S. provisional patent application Ser. No. 63/181,905 filed on Apr. 29, 2021.

### FIELD OF THE INVENTION

The present invention relates generally to a rehabilitation apparatus. More specifically, the present invention is a system of rehabilitation apparatus for deep myofascial release and stretching that provides higher point of pressure release to allow for better leverage.

### BACKGROUND OF THE INVENTION

Myofascial release is such a necessary tool in sports medicine, fitness, physical therapy, and overall general body maintenance. Foam rollers, lacrosse or softballs, and various myofascial release tools have become a staple in training rooms, gyms, homes, and doctor's offices around the globe. The aforementioned myofascial release tools are generally placed on the floor or the ground surface so that the users can perform their exercises. Unfortunately, because of the flat configuration of the floor and a lack of leverage for the user, there are some important areas of the user's body where these aforementioned myofascial release tools fail. It is nearly impossible to get a deep and thorough release of muscles like the hamstring or the gastrocnemius or even smaller upper extremity muscles like the wrist flexors/extensors due to these shortcomings. There is also a lack of a tool that allows for both myofascial release of the entire body as well as flexibility enhancement. This lack of leverage is a direct result of aforementioned myofascial release tools being used on the floor. More specifically, it is impossible to acquire adequate leverage to put sufficient pressure on the muscle tissues in order to release them when the aforementioned myofascial release tools are placed on the floor or the ground surface.

It is an objective of the present invention to solves the leverage problem by lifting the point of contact of the exercising apparatus from the floor or the ground surface. More specifically, a pressure releasing roller of the present invention is adjustably elevated from the floor or the ground surface thus providing sufficient leverage for the user via a pair of handles. As a result, the user can utilize the pair of handles to grasp the present invention and use their full body weight as pressure for myofascial/tension release.

### BRIEF DESCRIPTION OF THE DRAWINGS

FIG. 1 is a perspective view of the first embodiment of the present invention.

FIG. 2 is an exploded view of the first embodiment of the present invention.

FIG. 3 is a perspective view of the second embodiment of the present invention.

FIG. 4 is an exploded view of the second embodiment of the present invention.

FIG. 5 is a perspective view of the third embodiment of the present invention.

FIG. 6 is an exploded view of the third embodiment of the present invention.

FIG. 7 is a perspective view of the fourth embodiment of the present invention.

FIG. 8 is an exploded view of the fourth embodiment of the present invention.

FIG. 9 is an exploded view of the support arm of the second, third, and fourth embodiment of the present invention.

FIG. 10 is another embodiment for the endcap of the present invention.

FIG. 11 is another embodiment for the endcap of the present invention.

FIG. 12 is another embodiment for the endcap of the present invention.

FIG. 13 is another embodiment for the pressure releasing attachment of the present invention.

FIG. 14 is another embodiment for the pressure releasing attachment of the present invention.

FIG. 15 is another embodiment for the pressure releasing attachment of the present invention.

FIG. 16 is another embodiment for the pressure releasing attachment of the present invention.

FIG. 17 is another embodiment for the pressure releasing attachment of the present invention.

### DETAIL DESCRIPTIONS OF THE INVENTION

All illustrations of the drawings are for the purpose of describing selected versions of the present invention and are not intended to limit the scope of the present invention.

Myofascial release is such a necessary tool in sports medicine, fitness, and physical therapy. Existing myofascial release devices only focus on some parts of the user's and does not function as entire body myofascial release tool. Due to the positioning on the floor/ground and a lack of leverage, existing myofascial release devices are unable to provide a deep and thorough release of muscles like the hamstring or the gastrocnemius or even smaller upper extremity muscles like the wrist flexors/extensors. The present invention is a rehabilitation apparatus for deep myofascial release and stretching and provides solutions aforementioned limitations. The present invention provides an adjustable and elevated pressure releasing roller from the floor/ground so that the user can utilize their full body weight as pressure for myofascial/tension release.

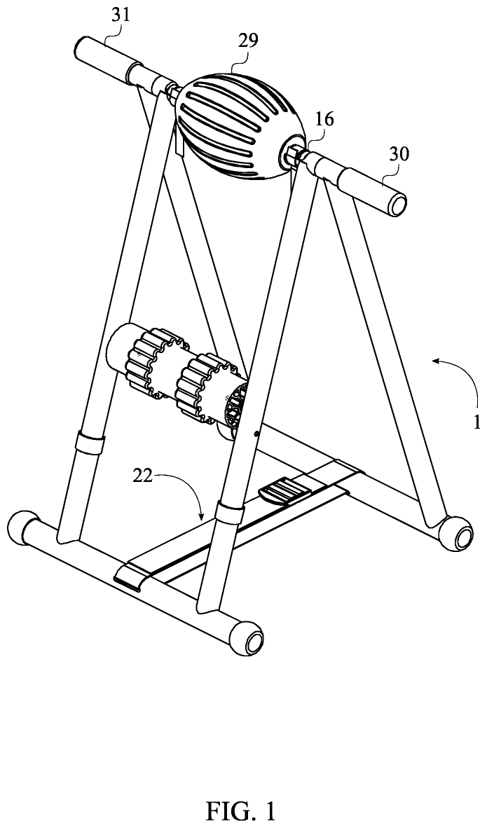

As shown in FIGS. 1, 3, 5, and 7, the present invention comprises an elevated frame 1, at least one support arm 16, a height adjustable mechanism 22, at least one pressure releasing attachment 29, a first handle 30, and a second handle 31. In reference to the general configuration, the elevated frame 1 is a structural body that elevates the support arm 16, the height adjustable mechanism 22, the pressure releasing attachment 29, the first handle 30, and the second handle 31 from the floor/ground surface. The pressure releasing attachment 29 is rotatably attached to the support arm 16 so that the user can use their body weight to rotate the pressure releasing attachment 29. The support arm 16 is operatively coupled to the elevated frame 1, wherein the support arm 16 enables the pressure releasing attachment 29 to rotate above the floor/ground surface. The height adjustable mechanism 22 is operatively coupled to the elevated frame 1, wherein the height adjustable mechanism 22 changes the operational height of the pressure releasing attachment 29 in relation to the elevated frame 1. The first handle 30 and the second handle 31 are oppositely positioned of each other about the pressure releasing attachment 29 so that the user can attain the maximum leverage during usage of the present invention. The first handle 30 is mounted to the elevated frame 1, and the second handle 31 is mounted to the elevated frame 1. The present invention is explained in relations four different embodiments without departing from the scope of the invention.

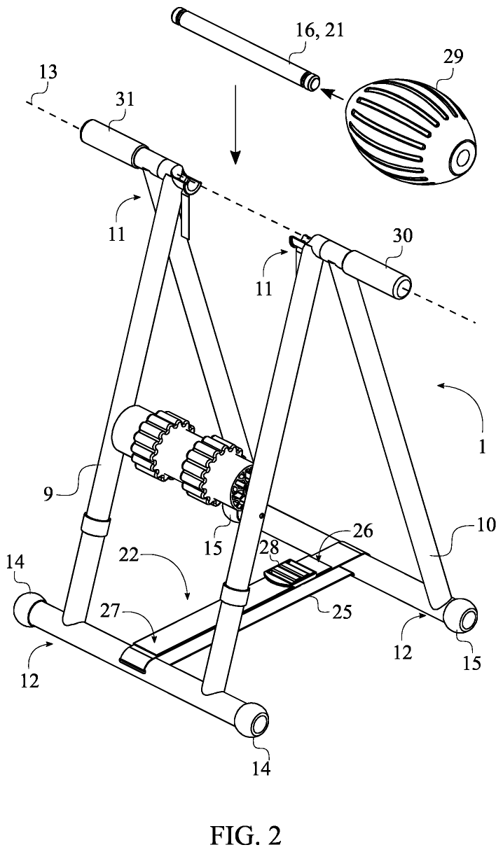

In reference to a first embodiment of the present invention, the elevated frame 1 comprises a first frame 9, a second frame 10, and a central axis 13 as show in FIGS. 1 and 2. The elevated frame 1 is preferably made of steel or aluminum and formed into an upside-down V-shape similar to that of a small step ladder to raise the tools to their optimum position. More specifically, a proximal end 11 of the first frame 9 and a proximal end 11 of the second frame 10 are adjustably connected to each other along the central axis 13. The first frame 9 is angularly positioned to the second frame 10 at an acute angle so that the connection points of the first frame 9 and the second frame 10 can maintain the maximum structural integrity. The height adjustable mechanism 22 is connected to a distal end 12 of the first frame 9 and a distal end 12 of the second frame 10 so the user can adjust the height of the central axis 13. In other words, when the acute angle is reduced via the height adjustable mechanism 22, the height of the central axis 13 increases. When the acute angle is increased via the height adjustable mechanism 22, the height of the central axis 13 decreases. The first handle 30 is axially positioned along the central axis 13 and attached to the proximal end 11 of the first frame 9 and the second frame 10. The second handle 31 is axially positioned along the central axis 13 and attached to the proximal end 11 of the first frame 9 and the second frame 10, opposite of the first handle 30. Preferably, the first handle 30 and the second handle 31 are screwed into the proximal end 11 of the first frame 9 and the second frame 10.

In reference to FIG. 2, the support arm 16 of the first embodiment that enables the rotation of the pressure releasing attachment 29 comprises a shaft 21. More specifically, the shaft 21 is axially positioned in between the first handle 30 and the second handle 31. The shaft 21 is axially positioned along the central axis 13 thus allowing the shaft 21 to be attached to the proximal end 11 of the first frame 9 and the proximal end 11 of the second frame 10. As a result, the pressure releasing attachment 29 is rotatably attached to the shaft 21 so that the pressure releasing attachment 29 can be rotate around the central axis 13. Due to the removable connection between the shaft 21 and the elevated frame 1, the user can anytime remove the shaft 21 when the pressure releasing attachment 29 needs to be interchanged.

In reference to FIG. 2, the height adjustable mechanism 22 of the first embodiment comprises a strap 25 and a buckle 28 so that the height of the central axis 13 can be adjusted according to the user's requirements. The strap 25 is slidably engaged with the distal end 12 of the first frame 9 and the distal end 12 of the second frame 10 as a loop so that the length of the strap 25 can be adjusted via the buckle 28. More specifically, a fixed end 26 of the strap 25 is connected to the buckle 28 thus allowing a free end 27 of the strap 25 to be looped through the elevated frame 1 and adjustably engaged with the buckle 28.

In reference to FIG. 2, the first embodiment further comprises a first pair of wheels 14 and a second pair of wheels 15 so that the elevated frame 1 can easily be moved from one place to another. More specifically, the first pair of wheels 14 is mounted to the distal end 12 of the first frame 9. The second pair of wheels 15 is mounted to the distal end 12 of the second frame 10. Furthermore, the first pair of wheels 14 and the second pair of wheels 15 can be locked or unlocked depending upon the intended usage. For example, when the elevated frame 1 is moved from one place to another, the first pair of wheels 14 and the second pair of wheels 15 are configured to an unlocked position. When the pressure releasing attachment 29 is operational, the first pair of wheels 14 and the second pair of wheels 15 are configured to a locked position.

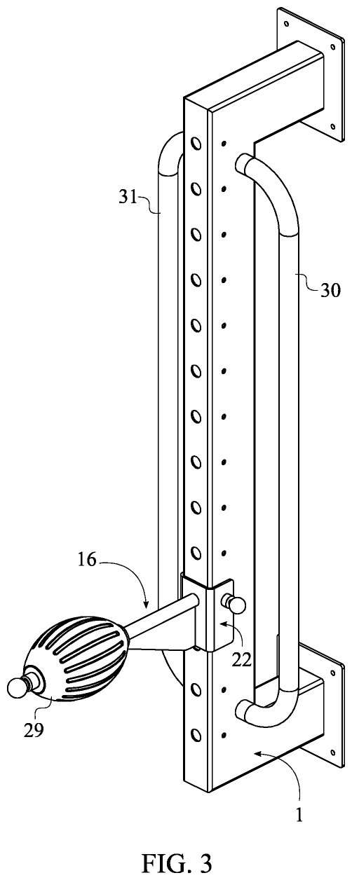

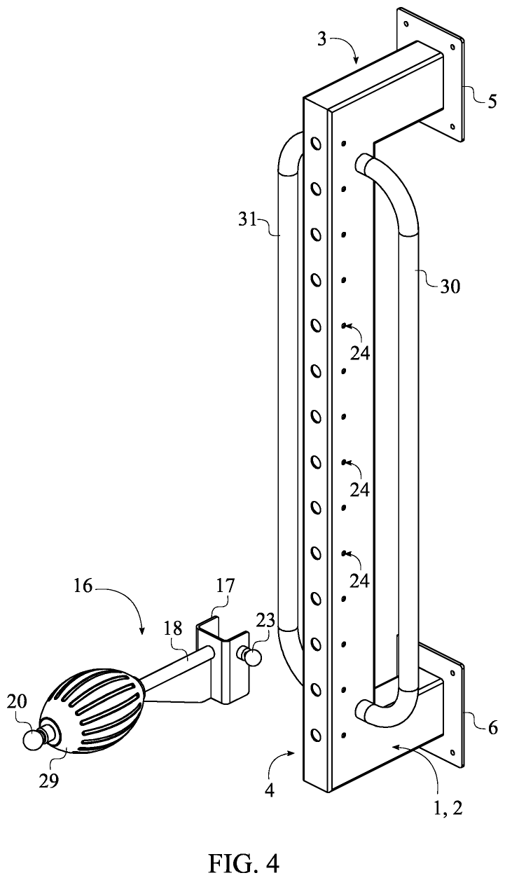

In reference to a second embodiment of the present invention, the elevated frame 1 comprises a vertical frame 2, a top wall mount 5, and a bottom wall mount 6 as show in FIGS. 3 and 4. The elevated frame 1 is preferably made of steel or aluminum and formed into a structural column. The support arm 16 is mounted to the vertical frame 2 through the height adjustable mechanism 22 so that the user is able to move and secure the support arm 16 up and down along the height of the vertical frame 2. The first handle 30 being mounted to the vertical frame 2 and extended from a top end 3 of the vertical frame 2 to a bottom end 4 of the vertical frame 2. The second handle 31 is mounted to the vertical frame 2 and positioned opposite of the first handle 30, wherein the second handle 31 is extended from the top end 3 of the vertical frame 2 to the bottom end 4 of the vertical frame 2. As shown in FIG. 4, the top wall mount 5 is perpendicularly positioned to the vertical frame 2 and terminally connected to the top end 3 of the vertical frame 2. As a result, the top wall mount 5 can be utilized to secure the top end 3 of the vertical frame 2 to a vertical wall structure and offset from the wall surface. As shown in FIG. 4, the bottom wall mount 6 is perpendicularly positioned to the vertical frame 2 and terminally connected to the bottom end 4 of the vertical frame 2. As a result, the bottom wall mount 6 can be utilized to secure the bottom end 4 of the vertical frame 2 to the vertical wall structure and offset from the wall surface.

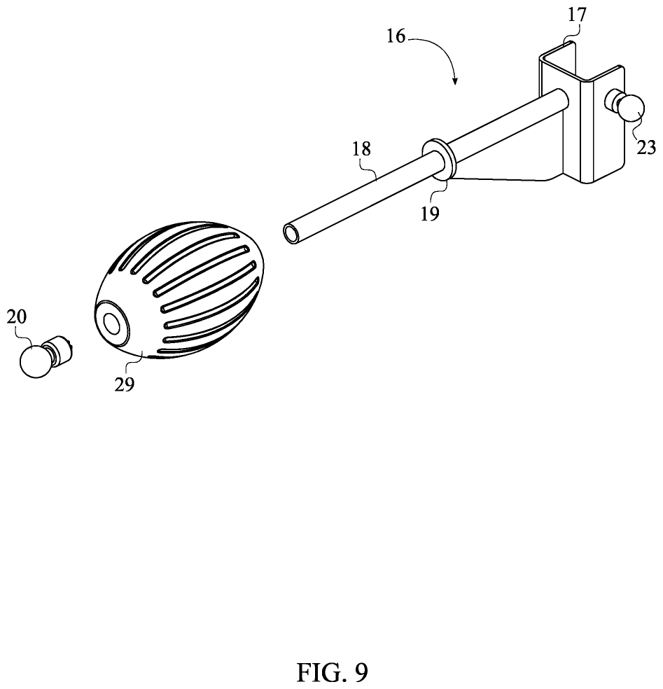

In reference to FIG. 4 and FIG. 9, the support arm 16 of the second embodiment that enables the rotation of the pressure releasing attachment 29 comprises a bracket 17, an elongated arm 18, a stopper 19, and an endcap 20. More specifically, the elongated arm 18 is terminally connected to the bracket 17 and outwardly extended from the bracket 17. The stopper 19 is radially connected around the elongated arm 18 and offset from the bracket 17. The endcap 20 is terminally mounted to the elongated arm 18 and positioned opposite of the bracket 17 to cover the free-end of the elongated arm 18. The pressure releasing attachment 29 is rotatably attached to the elongated arm 18 and positioned in between the stopper 19 and the endcap 20. In other words, the stopper 19 and the endcap 20 function as barriers to prevent any lateral movement of the pressure releasing attachment 29 along the elongated arm 18. Due to the removable connection between the elongated arm 18 and the endcap 20, the user can anytime remove the endcap 20 when the pressure releasing attachment 29 needs to be interchanged.

In reference to FIG. 4, the height adjustable mechanism 22 of the second embodiment comprises a locking pin 23 and a plurality of locking openings 24. More specifically, the locking pin 23 is compressionally engaged through the bracket 17. The plurality of locking openings 24 linearly traverses into the vertical frame 2 and extended from the top end 3 to the bottom end 4. Resultantly, the locking pin 23 can be selectively engaged with one of the plurality of locking openings 24 to maintain a fixed position to the support arm 16 of the second embodiment. In other word, the height adjustable mechanism 22 of the second embodiment gives the user the option to bring the pressure releasing attachment 29 to a preferred level according to one's height or the specific muscle of the user's body.

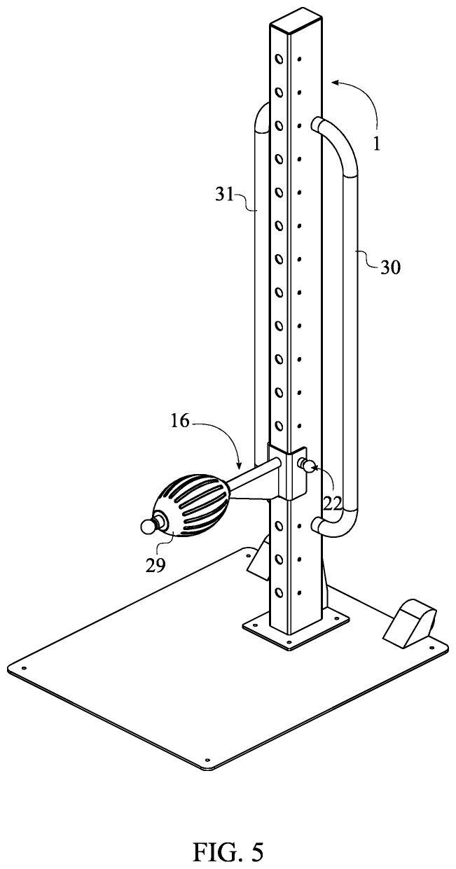

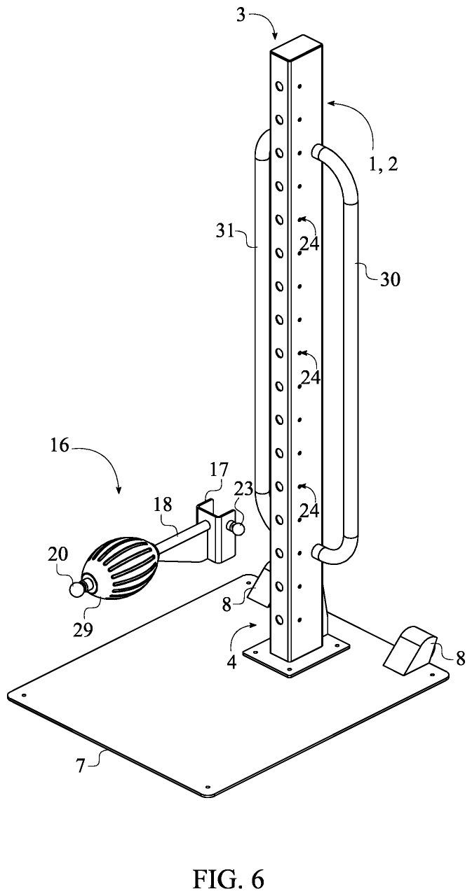

In reference to a third embodiment of the present invention, the elevated frame 1 comprises the vertical frame 2 and a base plate 7 as show in FIGS. 5 and 6. The elevated frame 1 is preferably made of steel or aluminum and formed into a structural column. The support arm 16 is mounted to the vertical frame 2 through the height adjustable mechanism 22 so that the user is able to move and secure the support arm 16 up and down along the height of the vertical frame 2. The first handle 30 being mounted to the vertical frame 2 and extended from the top end 3 of the vertical frame 2 to the bottom end 4 of the vertical frame 2. The second handle 31 is mounted to the vertical frame 2 and positioned opposite of the first handle 30, wherein the second handle 31 is extended from the top end 3 of the vertical frame 2 to the bottom end 4 of the vertical frame 2. As shown in FIG. 6, the bottom end 4 of the vertical frame 2 is connected atop the base plate 7. The base plate 7 functions as a weighted base structure so that the second embodiment can be positioned upright on the floor. As a result, the height of the vertical frame 2 and base plate 7 are able to offset the pressure releasing attachment 29 from the floor. Furthermore, the third embodiment of the present invention comprises at least one pair of wheels 8 that is connected to the base plate 7. The least one pair of wheels and the vertical frame 2 are oppositely positioned of each other about the base plate 7 thus enabling the user to tilt and move the third embodiment from one place to another via the least one pair of wheels.

In reference to FIGS. 6 and 9, the support arm 16 of the third embodiment that enables the rotation of the pressure releasing attachment 29 comprises the bracket 17, the elongated arm 18, the stopper 19, and the endcap 20. More specifically, the elongated arm 18 is terminally connected to the bracket 17 and outwardly extended from the bracket 17. The stopper 19 is radially connected around the elongated arm 18 and offset from the bracket 17. The endcap 20 is terminally mounted to the elongated arm 18 and positioned opposite of the bracket 17 to cover the free-end of the elongated arm 18. The pressure releasing attachment 29 is rotatably attached to the elongated arm 18 and positioned in between the stopper 19 and the endcap 20. In other words, the stopper 19 and the endcap 20 function as barriers to prevent any lateral movement of the pressure releasing attachment 29 along the elongated arm 18. Due to the removable connection between the elongated arm 18 and the endcap 20, the user can anytime remove the endcap 20 when the pressure releasing attachment 29 needs to be interchanged.

In reference to FIG. 6, the height adjustable mechanism 22 of the third embodiment comprises the locking pin 23 and the plurality of locking openings 24. More specifically, the locking pin 23 is compressionally engaged through the bracket 17. The plurality of locking openings 24 linearly traverses into the vertical frame 2 and extended from the top end 3 to the bottom end 4. Resultantly, the locking pin 23 can be selectively engaged with one of the plurality of locking openings 24 to maintain a fixed position to the support arm 16 of the third embodiment. In other word, the height adjustable mechanism 22 of the third embodiment gives the user the option to bring the pressure releasing attachment 29 to a preferred level according to one's height or the specific muscle of the user's body.

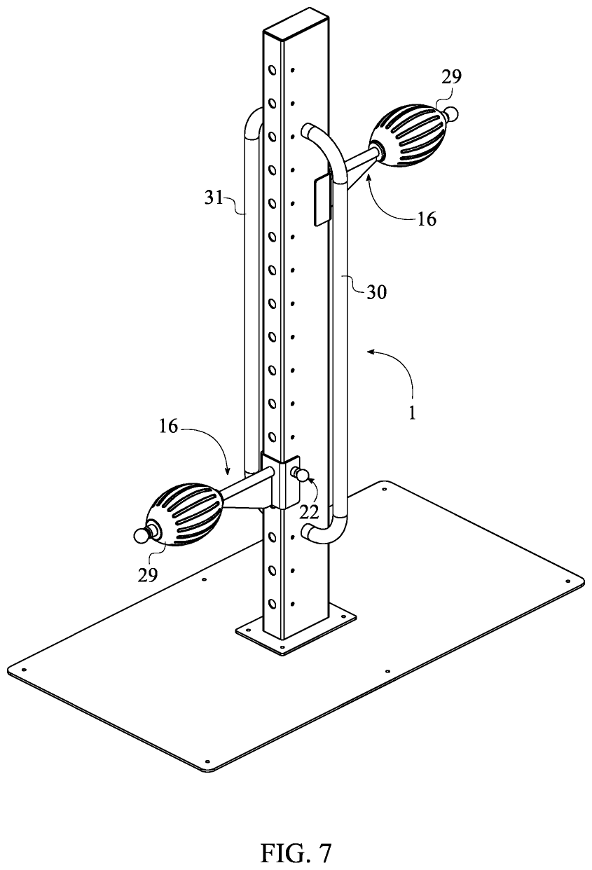

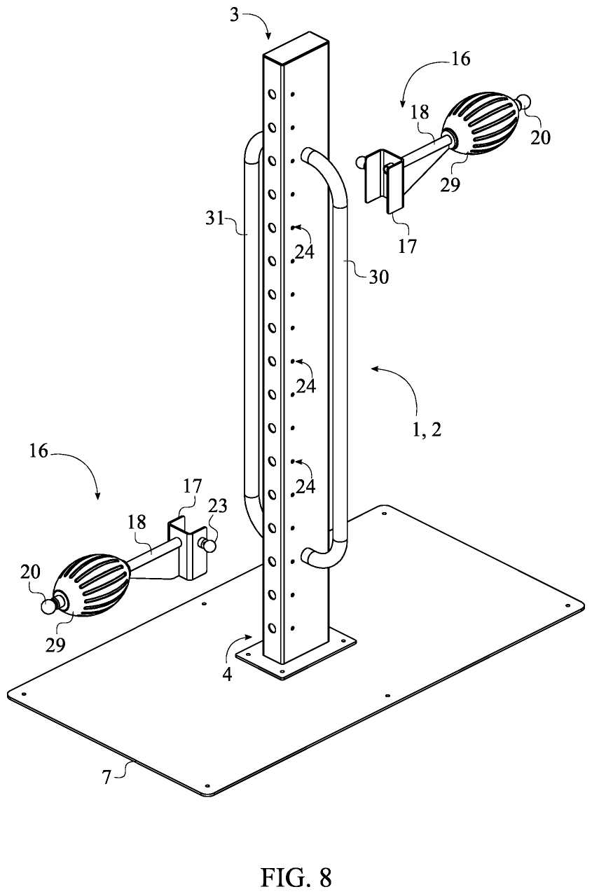

In reference to a fourth embodiment of the present invention, the elevated frame 1 comprises the vertical frame 2 and a base plate 7 as show in FIGS. 7 and 8. The elevated frame 1 is preferably made of steel or aluminum and formed into a structural column. The support arm 16 is mounted to the vertical frame 2 through the height adjustable mechanism 22 so that the user is able to move and secure the support arm 16 up and down along the height of the vertical frame 2. The first handle 30 being mounted to the vertical frame 2 and extended from the top end 3 of the vertical frame 2 to the bottom end 4 of the vertical frame 2. The second handle 31 is mounted to the vertical frame 2 and positioned opposite of the first handle 30, wherein the second handle 31 is extended from the top end 3 of the vertical frame 2 to the bottom end 4 of the vertical frame 2. As shown in FIG. 8, the bottom end 4 of the vertical frame 2 is connected atop the base plate 7. The base plate 7 functions as a weighted base structure so that the second embodiment can be positioned upright on the floor. As a result, the height of the vertical frame 2 and base plate 7 are able to offset the pressure releasing attachment 29 from the floor.

In reference to FIGS. 8 and 9, the at least one support arm 16 of the fourth embodiment comprises a first support arm and a second support arm. The first support arm and the second support arm are oppositely positioned of each other about the vertical frame 2 and operates independent of each other. The first support arm and the second support arm each comprises the bracket 17, the elongated arm 18, the stopper 19, and the endcap 20. More specifically, the elongated arm 18 is terminally connected to the bracket 17 and outwardly extended from the bracket 17. The stopper 19 is radially connected around the elongated arm 18 and offset from the bracket 17. The endcap 20 is terminally mounted to the elongated arm 18 and positioned opposite of the bracket 17 to cover the free-end of the elongated arm 18. The pressure releasing attachment 29 is rotatably attached to the elongated arm 18 and positioned in between the stopper 19 and the endcap 20. In other words, the stopper 19 and the endcap 20 function as barriers to prevent any lateral movement of the pressure releasing attachment 29 along the elongated arm 18. Due to the removable connection between the elongated arm 18 and the endcap 20, the user can anytime remove the endcap 20 when the pressure releasing attachment 29 needs to be interchanged.

In reference to FIG. 8, the height adjustable mechanism 22 of the fourth embodiment comprises the locking pin 23 and the plurality of locking openings 24. More specifically, the locking pin 23 is compressionally engaged through the bracket 17. The plurality of locking openings 24 linearly traverses into the vertical frame 2 and extended from the top end 3 to the bottom end 4. Resultantly, the locking pin 23 can be selectively engaged with one of the plurality of locking openings 24 to maintain a fixed position to the support arm 16 of the fourth embodiment. In other word, the height adjustable mechanism 22 of the fourth embodiment gives the user the option to bring the pressure releasing attachment 29 to a preferred level according to one's height or the specific muscle of the user's body.

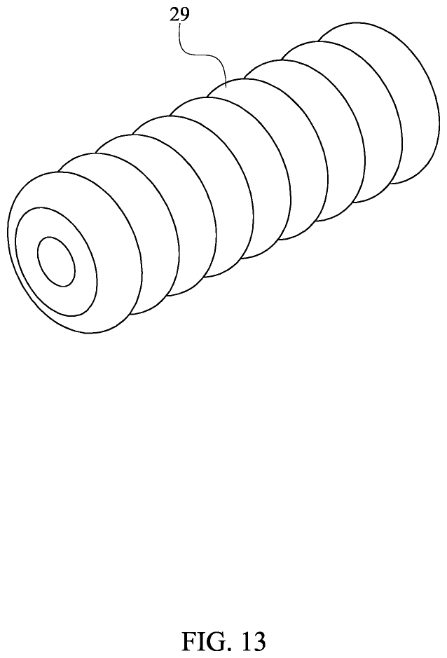

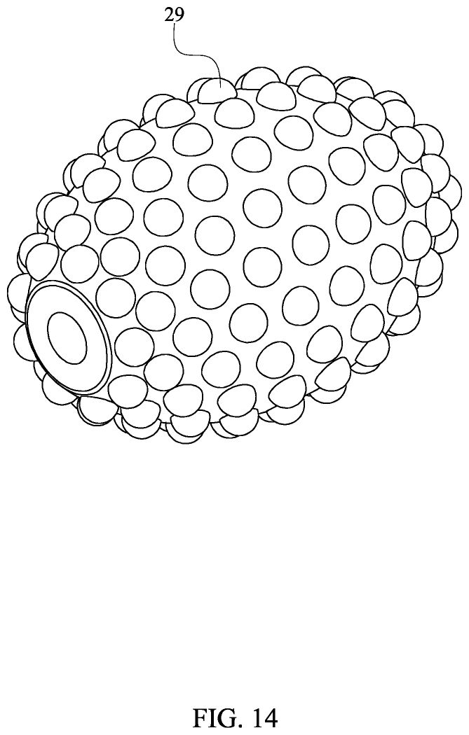

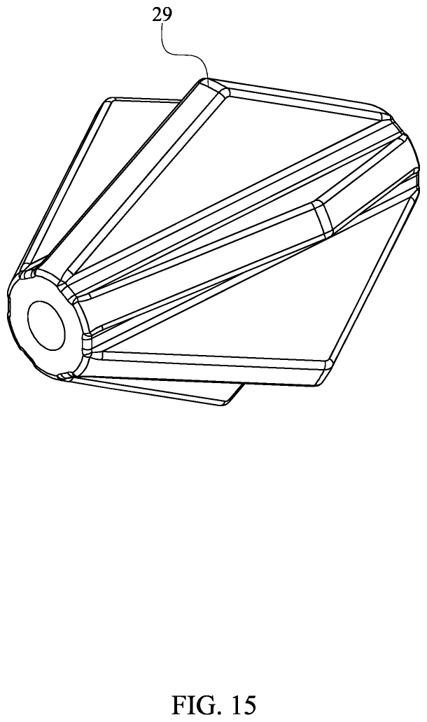

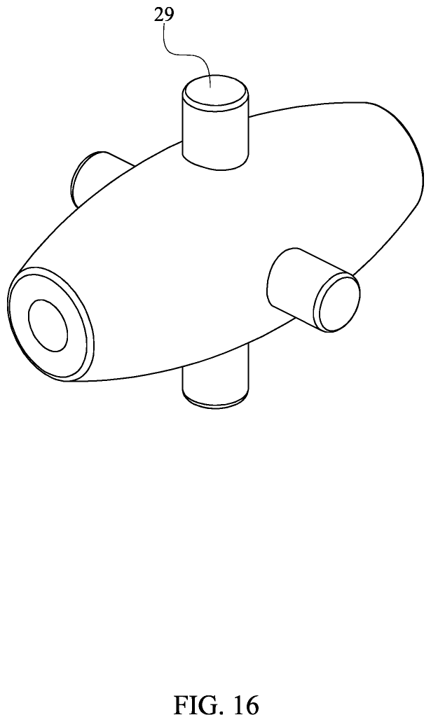

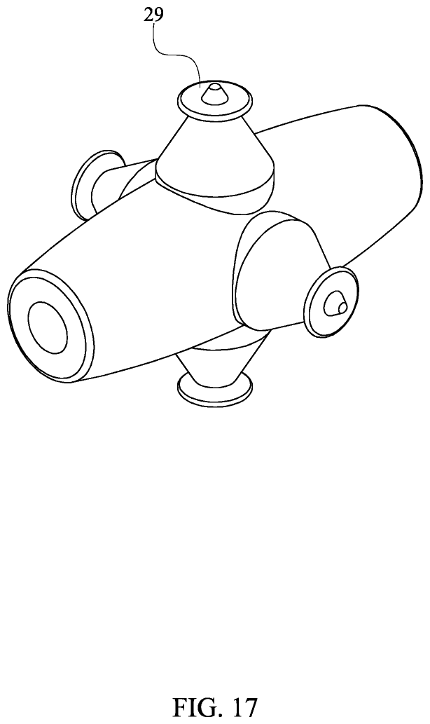

The pressure releasing attachment 29 can vary in degree of firmness, material, compression, type of exercise, type muscles that required deep myofascial release and stretching, type of textures, and any other related features. Optionally, the pressure releasing attachment 29 can incorporate heating and vibration elements for enhanced blood circulation and healing. FIG. 9 and FIGS. 13-17 shows different embodiments of the pressure releasing attachment 29 that are used within the present invention. Depending upon what muscle groups are being targeted for myofascial release, the user can easily interchange them from the support arm 16.

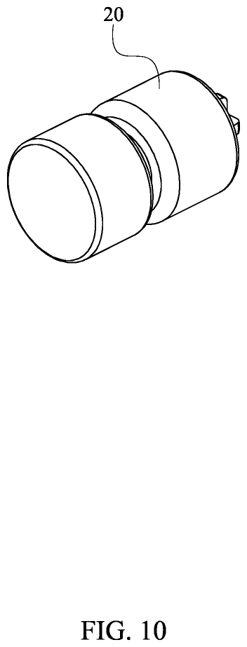

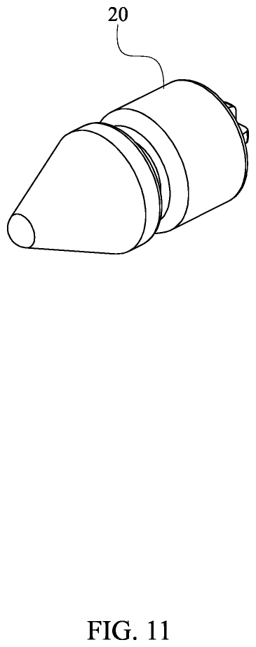

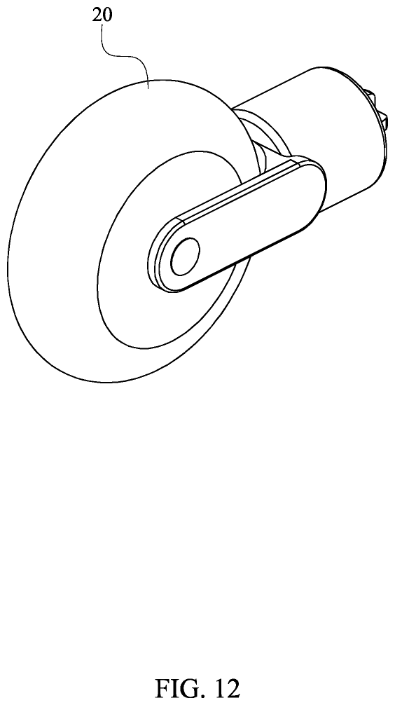

The endcap 20 utilized within the second embodiment, the third embodiment, and the fourth embodiment can also function as pressure releasing body within the present invention. More specifically, the user is able to select from different embodiments of the endcap 20 depending upon the user's requirements. As shown in FIGS. 9-12, the endcap 20 can be a dull end piece with flat surface, a round body (golf ball sized), a firm-pointed tip for pinpoint compression, or a rolling ball attachment for pinpoint rolling when compression is unwarranted.

Since the pressure releasing attachment 29 is raised off the floor/ground to allow the user to create leverage in order to use bodyweight for pressure application for myofascial release. Use of the first handle 30 and the second handle 31 allow the user to balance as well as pull when more than bodyweight is necessary. The varying embodiments of the pressure releasing attachment 29 is best suited for particular body parts. Overall, the ability to create leverage with these varying embodiments of the pressure releasing attachment 29 make for a more effective release. To use the present invention, one needs to place the desired body part upon the pressure releasing attachment 29 and use leverage and bodyweight to create adequate pressure to release tension in that particular region of muscle. When the pressure is applied, the user may simply hold position or move/roll the body part over the previously mentioned pressure releasing attachment 29.

Although the invention has been explained in relation to its preferred embodiment, it is to be understood that many other possible modifications and variations can be made without departing from the spirit and scope of the invention as hereinafter claimed.

What is claimed is:

1. A rehabilitation apparatus for deep myofascial release and stretching comprising:
an elevated frame;
at least one support arm;
a height adjustable mechanism;
at least one pressure releasing attachment;
a first handle;
a second handle;
the pressure releasing attachment being rotatably attached to the support arm;
the support arm being operatively coupled to the elevated frame, wherein the support arm enables the pressure releasing attachment to rotate above the floor surface;
the height adjustable mechanism being operatively coupled to the elevated frame, wherein the height adjustable mechanism changes the operational height of the pressure releasing attachment;
the first handle and the second handle being oppositely positioned of each other about the pressure releasing attachment;
the first handle being mounted to the elevated frame; and
the second handle being mounted to the elevated frame.

2. The rehabilitation apparatus for deep myofascial release and stretching as claimed in claim 1 comprising:
the elevated frame comprising a first frame, a second frame, and a central axis;
a proximal end of the first frame and a proximal end of the second frame being adjustably connected to each other along the central axis;
the first frame being angularly positioned to the second frame at an acute angle;
the height adjustable mechanism being connected to a distal end of the first frame and a distal end of the second frame;
the first handle being axially positioned along the central axis;
the first handle being attached to the proximal end of the first frame and the second frame;
the second handle being axially positioned along the central axis; and
the second handle being attached to the proximal end of the first frame and the second frame, opposite of the first handle.

3. The rehabilitation apparatus for deep myofascial release and stretching as claimed in claim 2 comprising:
a first pair of wheels;
a second pair of wheels;
the first pair of wheels being mounted to the distal end of the first frame; and
the second pair of wheels being mounted to the distal end of the second frame.

4. The rehabilitation apparatus for deep myofascial release and stretching as claimed in claim 2 comprising:
the support arm comprising a shaft;
the shaft being axially positioned in between the first handle and the second handle;
the shaft being axially positioned along the central axis;
the shaft being attached to the proximal end of the first frame and the proximal end of the second frame; and
the pressure releasing attachment being rotatably attached to the shaft.

5. The rehabilitation apparatus for deep myofascial release and stretching as claimed in claim 2 comprising:
the height adjustable mechanism comprising a strap and a buckle;
the strap being slidably engaged with the distal end of the first frame and the distal end of the second frame;
a fixed end of the strap being connected to the buckle; and
a free end of the strap being adjustably engaged with the buckle.

6. The rehabilitation apparatus for deep myofascial release and stretching as claimed in claim 1 comprising:
the elevated frame comprising a vertical frame;
the support arm being mounted to the vertical frame through the height adjustable mechanism;
the first handle being mounted to the vertical frame;
the first handle being extended from a top end of the vertical frame to a bottom end of the vertical frame;
the second handle being mounted to the vertical frame, opposite of the first handle; and
the second handle being extended from the top end of the vertical frame to the bottom end of the vertical frame.

7. The rehabilitation apparatus for deep myofascial release and stretching as claimed in claim 6 comprising:
the support arm comprising a bracket, an elongated arm, a stopper, and an endcap;
the elongated arm being terminally connected to the bracket;
the stopper being radially connected around the elongated arm;
the stopper being offset from the bracket;
the endcap being terminally mounted to the elongated arm, opposite of the bracket;
the pressure releasing attachment being rotatably attached to the elongated arm; and
the pressure releasing attachment being positioned in between the stopper and the endcap.

8. The rehabilitation apparatus for deep myofascial release and stretching as claimed in claim 6 comprising:
the height adjustable mechanism comprising a locking pin and a plurality of locking openings;
the locking pin being compressionally engaged through a bracket of the support arm;
the plurality of locking openings linearly traversing into a vertical frame of the elevated frame; and
the locking pin being selectively engaged with one of the plurality of locking openings.

9. The rehabilitation apparatus for deep myofascial release and stretching as claimed in claim 6 comprising:
a top wall mount;
the top wall mount being perpendicularly positioned to the vertical frame; and
the top wall mount being terminally connected to the top end of the vertical frame.

10. The rehabilitation apparatus for deep myofascial release and stretching as claimed in claim 6 comprising:
a bottom wall mount;
the bottom wall mount being perpendicularly positioned to the vertical frame; and
the bottom wall mount being terminally connected to the bottom end of the vertical frame.

11. The rehabilitation apparatus for deep myofascial release and stretching as claimed in claim 6 comprising:
a base plate; and
the bottom end of the vertical frame being connected atop the base plate.

12. The rehabilitation apparatus for deep myofascial release and stretching as claimed in claim 11 comprising:
at least one pair of wheels;
the least one pair of wheels being connected to the base plate; and
the least one pair of wheels and the vertical frame being oppositely positioned of each other about the base plate.
